(19) United States
(12) Patent Application Publication
(10) Pub. No.: US 2007/0289917 A1
(43) Pub. Date: Dec. 20, 2007

(54) SEPARATION SYSTEM AND METHOD OF OPERATING

(76) Inventors: John M. Mylin, Roscoe, IL (US); Rex A. Dieterle, Madison, WI (US)

Correspondence Address: MICHAEL BEST & FRIEDRICH LLP, ONE SOUTH PINCKNEY STREET, P O BOX 1806, MADISON, WI, 53701, US

(21) Appl. No.: 11/763,007

(22) Filed: Jun. 14, 2007

Related U.S. Application Data
(60) Provisional application No. 60/804,845, filed on Jun. 15, 2006.

(51) Int. Cl. B01D 35/28

(52) U.S. Cl. 210/435; 210/499; 210/497.01; 210/194

(57) ABSTRACT

A multi-phase separation system for liquids with dissolved solids and/or liquid/solid mixtures. The separation system can include four phases. One of the phases can include a crossflow filtration unit. The crossflow filtration unit can separate solids from the process fluid by flowing the process fluid in a crossflow orientation over a filter screen. The crossflow filtration unit can be drained of process fluid and cleaned by high pressure cleaning nozzles. The crossflow filtration unit can be configured to simplify or reduce the cost of downstream filtration phases. The phases may be used selectively and/or may be outfitted with various components to meet different system requirements.

### CROSS REFERENCE TO RELATED APPLICATIONS

This application claims the benefit of the filing date of U.S. Provisional Application No. 60/804,845 filed Jun. 15, 2006, the application incorporated by reference herein in its entirety.

### BACKGROUND

The present invention relates to a separation system including a crossflow filter device as well as a method of operating the same.

### SUMMARY

The present invention provides a system and apparatus for separating a mixed-phase fluid into a filtered liquid and at least one concentrated solid.

In one embodiment the invention provides a method for separating a mixed-phase fluid into a filtered liquid and at least one concentrated solid. The first phase of separation comprises filtering the multi-phase fluid with a standard filter to remove large solids and producing a filtered working fluid. The working fluid then moves through a second phase of separation comprising the use of a crossflow separator in which the working fluid is directed through at least one filter screen. In this phase, the working fluid can have a velocity component that is perpendicular to the filter screen and a velocity component that is parallel to the filter screen. The working fluid then moves through a third phase of separation comprising the use of a membrane filter. The working fluid then moves through a fourth phase of separation comprising the use of a reverse osmosis membrane filter.

In another embodiment the invention provides a filter device for processing a multi-phase fluid into a filtered liquid portion. The multi-phase fluid is introduced into a crossflow filtration unit. The crossflow filtration unit comprises a housing and a filter screen positioned on the inside of the housing. The multiphase fluid enters into the housing through an input opening having a tangential orientation to impart a helical flow of the multi-phase fluid as it is pumped from the inlet end of the housing to an outlet end of the housing.

Other aspects of the invention will become apparent by consideration of the detailed description and accompanying drawings.

### BRIEF DESCRIPTION OF THE DRAWINGS

FIG. 1 is a process flow diagram of a four-phase separation system used for filtration of manure waste according to one embodiment of the invention;

FIG. 2 is a front view of the crossflow filtration unit of the present invention showing the longitudinal and latitudinal axes of the unit;

FIG. 3 is a cutaway top view of the crossflow filtration unit of the present invention showing the radial axes of the unit;

FIG. 4 is a front view of the crossflow filtration unit of the present invention;

FIG. 5 is a cutaway view of the crossflow filtration unit of the present invention;

FIG. 6 is a cutaway side view of one embodiment of a filter screen used in the crossflow filtration unit;

FIG. 7 is a perspective view of one example of a rotational device used in the spray cleaning unit of the crossflow filtration unit;

FIG. 8 is a perspective view of one example of a high pressure inlet used in the spray cleaning unit of the crossflow filtration unit;

FIG. 9 is a perspective view of the central spray pipe and spray nozzles of the spray cleaning unit of the crossflow filtration unit;

FIG. 10 is a top cutaway view of a cylindrical filter screen used in one embodiment of the crossflow filtration unit;

FIG. 11 is a partial side cutaway view of a filter screen used in one embodiment of the crossflow filtration unit;

FIG. 12 is a partial side cutaway view of a filter screen used in one embodiment of the crossflow filtration unit;

FIG. 13 is a partial side cutaway view of a filter screen used in one embodiment of the crossflow filtration unit as well as a magnified portion of this screen;

FIG. 14 illustrates the different stages of operation of the crossflow filtration unit;

FIG. 15 shows a front view of three crossflow filtration units connected in series.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. The term “operatively connected” refers to the fact that the connected parts work together as one of ordinary skill in the art would expect, for example where one filter is operatively connected to another filter, the filtered water output from one filter is the input to the other filter.

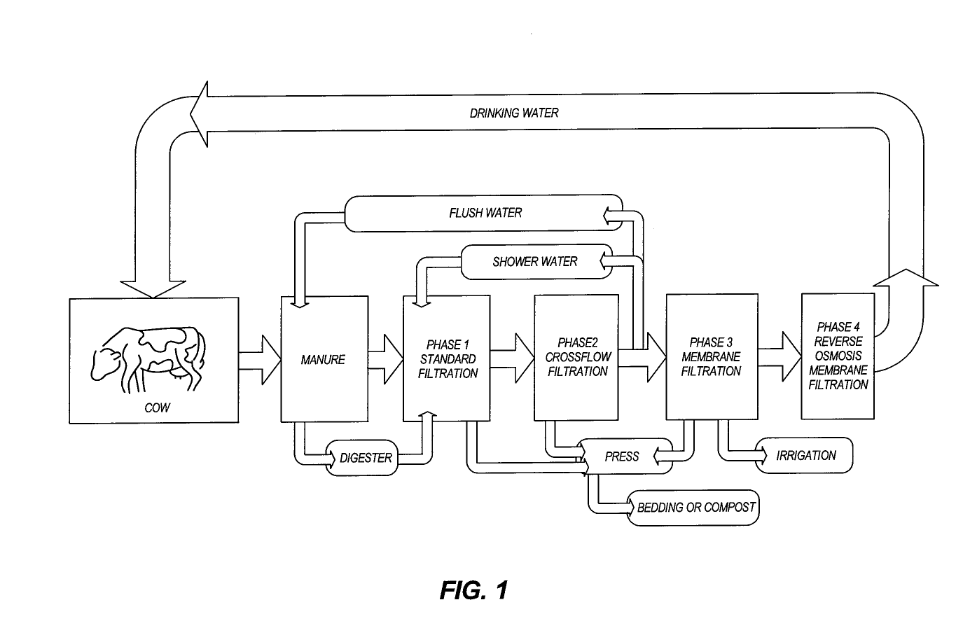

The present invention provides a system and apparatus for separating a mixed-phase fluid into a filtered liquid and at least one concentrated solid. FIG. 1 illustrates a separation system for separating components of a mixed-phase fluid according to one embodiment of the invention. The separation system illustrated in FIG. 1 is a waste recovery system, in which the mixed-phase fluid can be manure. In other embodiments, the separation system can be configured to process and separate a wide array of process fluids in accordance with the features and methods as described in further detail below.

In the waste recovery system of FIG. 1, an animal, a dairy cow for example, ingests feed and water and naturally produces a proportional amount of waste matter (i.e., manure) for processing. The waste recovery system can include different phases for processing the manure into segregated usable components. In the illustrated embodiment, the waste recovery system includes four phases. In other embodiments, the waste recovery system can include one, two, three, or greater than four phases for processing the manure.

The first phase of the separation system of FIG. 1 provides rough solids removal. The process fluid, which is manure in the illustrated embodiment, can contain a liquid fraction and a solid fraction. Among the solid fraction, particles of various sizes exist. The first phase of the system is done to remove most of the large particle solids and suitably can remove at least about 65 percent of all the solids from the process fluid. Numerous filtration apparatus can be used to perform this first separation, including a dissolved air floatation (DAF) separator, a centrifuge, a rotary drum screen filter, a stationary inclined screen, a screw press, a roller press, a belt press, or a digester, all of which are commercially available. Alternatively, any combination of the forgoing separation apparatus can be used to perform the first separation.

In one embodiment, all long fibers and particles larger than about 400 to 250 microns are removed. These solids can be dry to the touch and can be lacking any objectionable odor. The solids can be used as a soil enhancer, sold as manure soil enhancer, or used as bedding. Additionally, about 50 percent of the total phosphorus, about 20 percent of the total potassium, and about 25 percent of the total nitrogen can be removed from the liquid fraction. In one embodiment, the first phase captures a high percentage of the suspended solids (e.g., in about the 50 to 65 percent range) and reduces the water content of the captured material about 5 to 10 fold. The concentrated solids can then be more easily processed (e.g., by a small hydraulic screw press) to remove the remaining water to produce a dry material in about the 40 to 60 percent solids range.

The first phase of the separation system can produce a first filtered liquid (including some relatively small solid particulate) and first concentrated solids. As illustrated in FIG. 1, the first concentrated solids can be combined with other solids (such as those removed from the filtered liquid downstream of the first phase) and further dehydrated. In some embodiments, the first concentrated solids can be dehydrated with a screw press. Once dehydrated in the screw press, the solids can be used for bedding or compost. The first filtered liquid can be routed to the second phase of the separation system for further processing.

The second phase of the separation system is used to separate the more medium sized solid particles from the first filtered liquid provided from the first phase. Suitably, the second phase can remove about 5 to 10 percent more solids from the first filtered liquid. The second separation phase is accomplished by the use of separation equipment to further reduce the particle size in the filtered liquid produced (second filtered liquid) to solid particles having a size range of about 250 to 50 microns. Suitably, the type of separation equipment that can accomplish this filtration can be a number of typical solid/liquid separation equipment such as a centrifuge, dead end filter banks, or a dissolved air flotation separator. Alternatively a crossflow filtration unit of the present invention can be used.

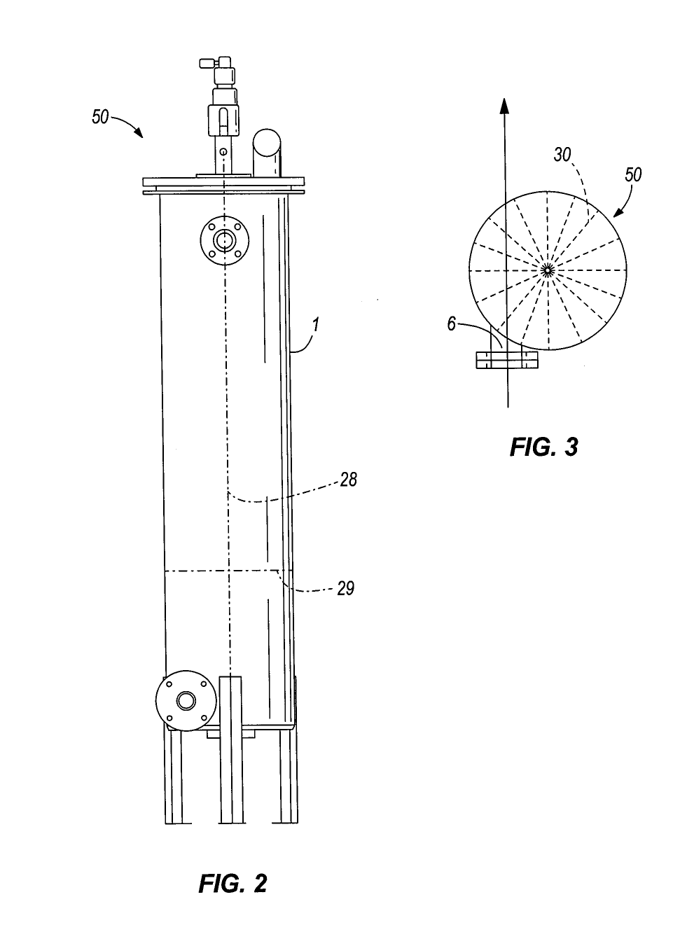

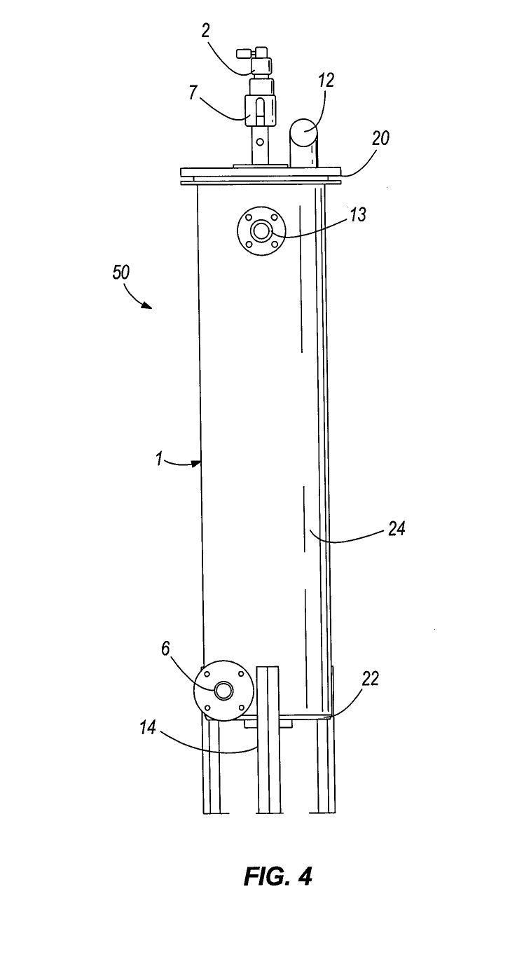

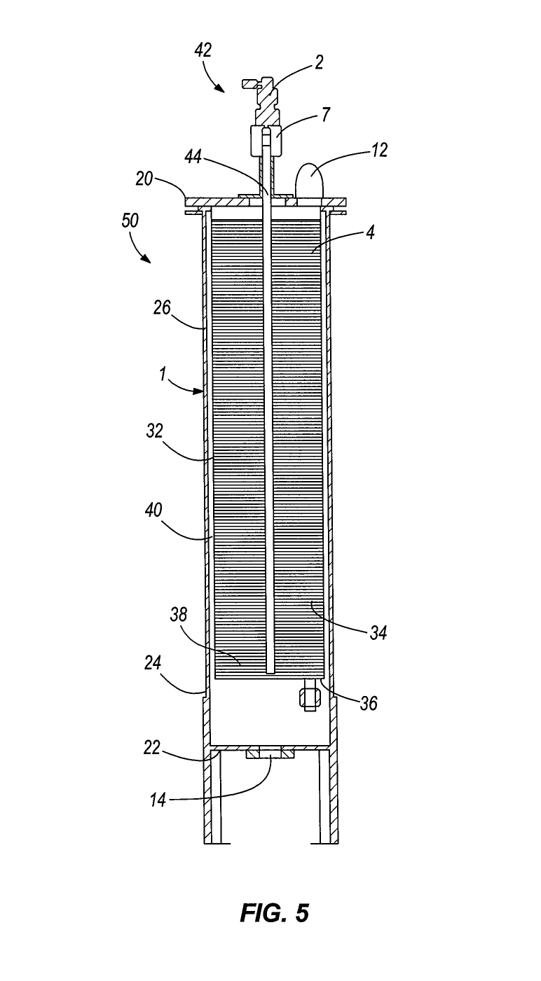

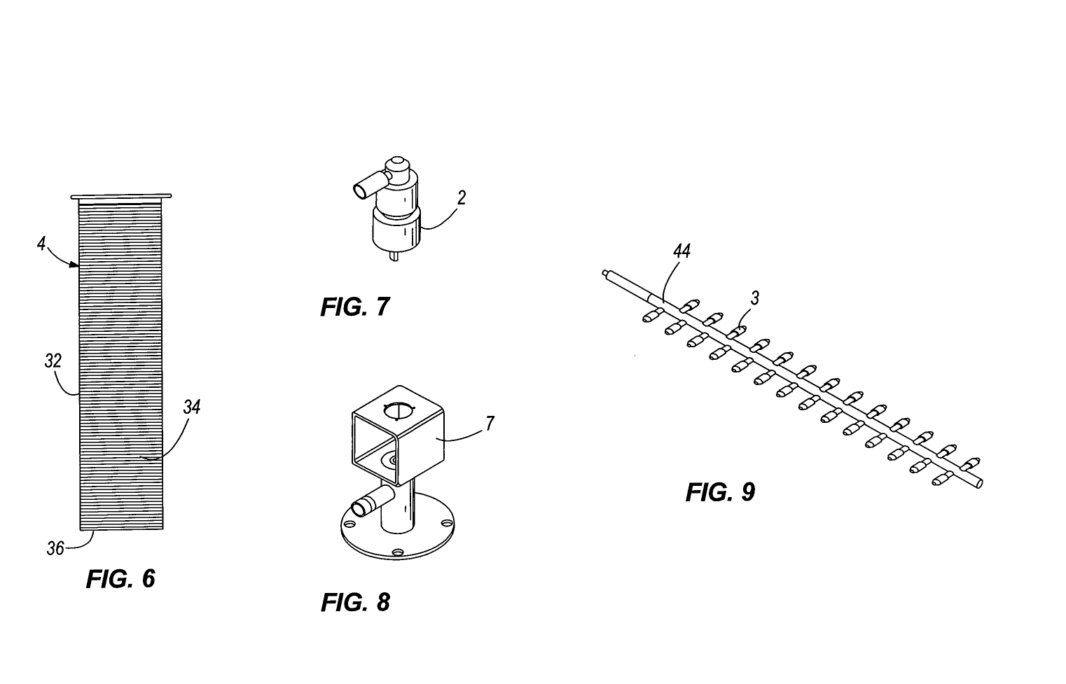

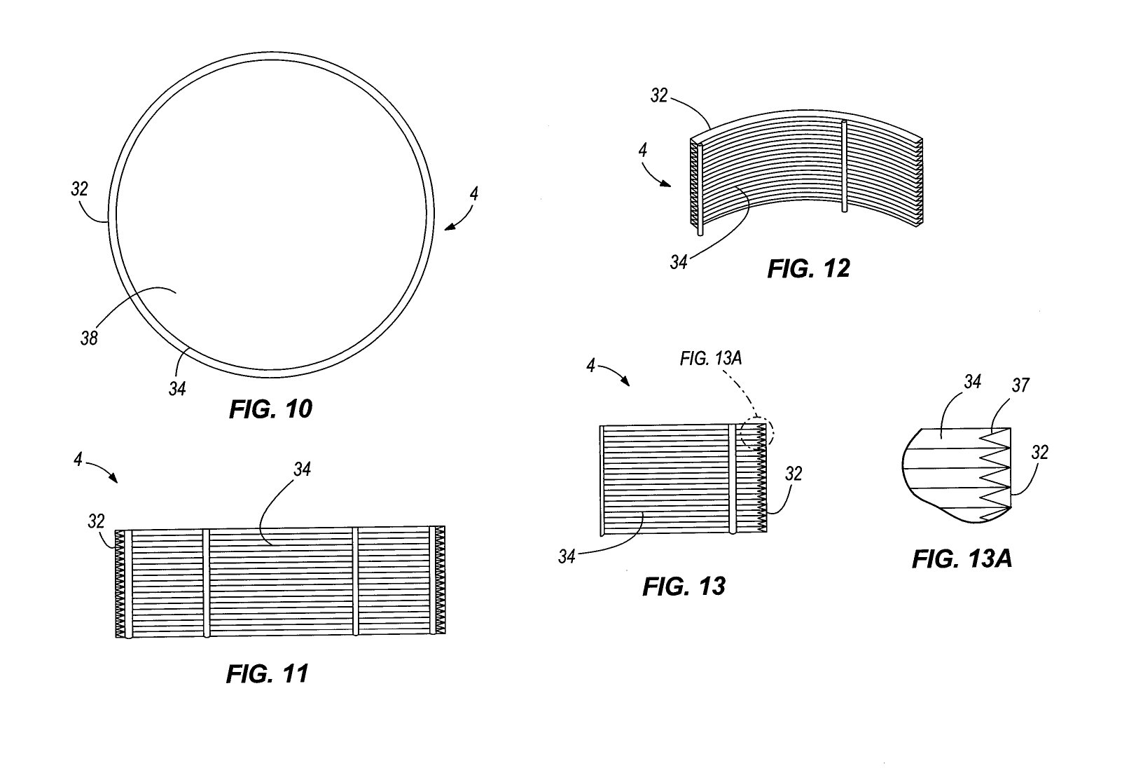

The crossflow filtration unit 50 is best shown in FIGS. 2-15. The crossflow filtration vessel comprises a housing 1 having a top 20, a bottom, 22, a sidewall 24, and inside 26, a longitudinal axis 28, a latitudinal axis 29 and radial axes 30. The housing 1, is suitably made of a 150 psi pressure rated, carbon steel or stainless steel vessel. The housing 1 is suitably cylindrical but can be of any suitable configuration. The housing also includes an inlet 6 for the multi-phase fluid, and an outlet for the filtered liquid 12.

The inlet 6 is suitably disposed near a bottom portion of the crossflow filtration housing 1 and is positioned to direct fluid in helical direction around the inside 26 of the housing 1. Successful crossflow filtration is aided by high velocity flow perpendicular to the permeate flow, to this end the inlet can be positioned such that it is perpendicular to the latitudinal axis 29 of the housing and is not aligned with any radial axis 30 of the housing 1. This arrangement is best shown in FIG. 3. The velocity of liquid entering the housing can suitably be increased by use of the crossflow pump 10 so that, in one embodiment, flow can be increased to 40 ft./sec from less than 10 ft./sec.

A filter screen 4 is disposed within the inside 26 of the crossflow filtration housing 1. The filter screen 4 has an exterior 32, an interior 34, and a bottom 36. The filter screen 4 defines an inside area 38 adjacent to the interior 34 of the filter screen 4 and an outside area 40 between the exterior 32 of the filter screen 4 and the housing 1.

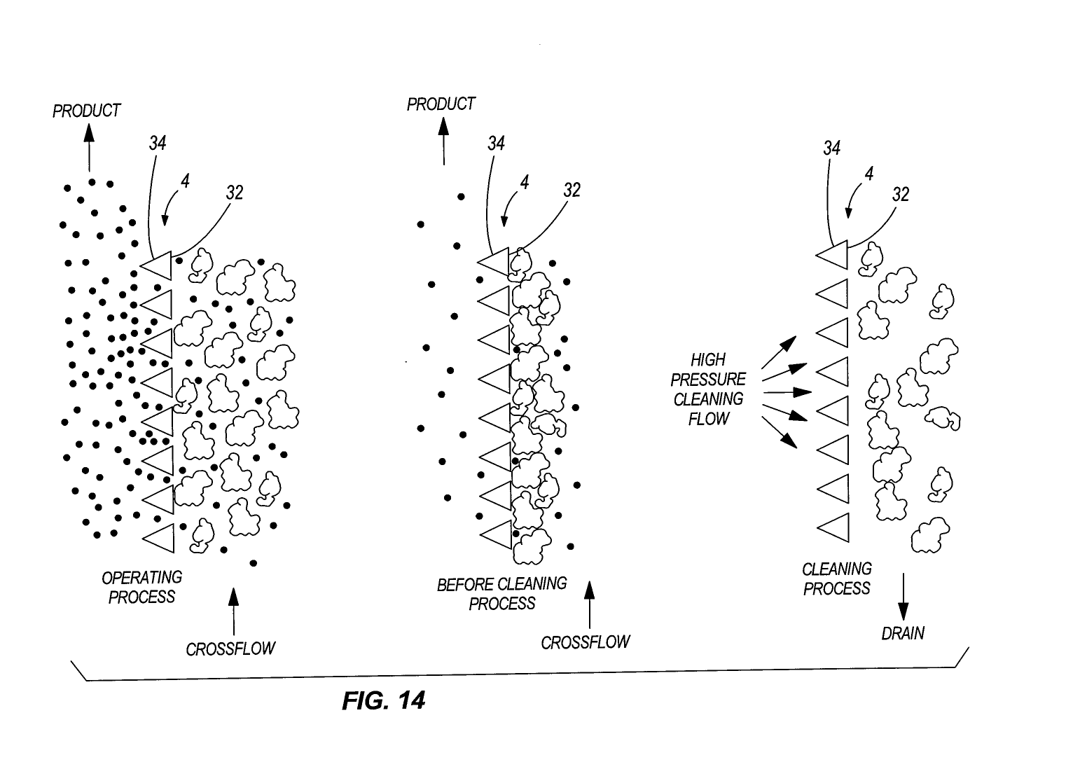

The screen 4, is suitably a standard wedge wire screen shaped in a round cylinder. The screen is designed for the flow to go from the exterior 32 of the screen 4 to the interior 34 of the screen 4. Suitably the wedge wire screen 4 is fabricated with “v grooves” 37 on the interior 34, with a smooth side on the exterior 32 facing the liquid. The exterior 32 of the screen 4 has open slots to allow the filtrate to pass to the inside (See FIG. 14). The wedge screen suitable has many sizes of micron openings. These openings can be of any suitable size. In one embodiment the openings are sized to allow for the passage of particles that are no larger than 50 microns to 400 microns in diameter. Suitably, the screen 4 is designed for 100 psi pressure drop across the screen. In one embodiment, to strengthen the screen 4, every 12 inches of length of the screen 4 has a stainless steel ring welded in between screen sections.

In certain embodiments a crossflow pump 10 is provided to pump the multi-phase fluid through inlet 6 in the crossflow filter 50. As described above, the inlet is positioned to allow for the flow of the multi-phase fluid through the crossflow filtration housing to be substantially swirling, or in a helical shape. The flow of the multi-phase fluid enters at the inlet 6 and flows generally toward the outlet 12 generally along the longitudinal axis of the crossflow filtration vessel, while also having a circumferential component, such that the flow rotates about the axis of the vessel. The flow orientation through the filter screen 4 is thus, not simply perpendicular to the screens, but having a parallel or tangential component, (i.e., a crossflow component). By this arrangement, a high pressure environment is created on the outside of the screen 4, causing the liquid to move through the filter screen 4 into the low pressure environment of the inside of the screen. The solid particles in the multi-phase fluid is filtered out as the liquid passes through the openings of the screen 4. The helical flow of the liquid also helps maintain the filter screens free of clogs during operation by continually cleaning or scrubbing the filter screens with the flow across them. The fluid that passes through the screen 4 exits the housing 1 through the outlet 12, which allows for fluid communication with the inside area 38 of the crossflow filter 50. In other embodiments the housing 1 also has a purge outlet 14, which is an outlet that allows for the drainage of the solids filtered by the crossflow filtration unit 50. Suitably the purge outlet is located on the bottom 22 of the housing 1 and allows for fluid communication with the outside area 40 of the crossflow filtration unit 50. The housing 1 can also have a recycle outlet 13. This recycle outlet 13 can suitably be positioned on the sidewall 24 of the housing 1 and allows for fluid communication with the outside area 40 of the filtration unit 50. The multi-phase fluid which does not pass through the screen 4, exits through the recycle outlet 13, and is re-circulated back into the crossflow filter through input 6.

The size of the housing 1 is dependent on the screen 4 size selected and can, in one embodiment, suitably be determined so as to provide a crossflow velocity of 2-4 ft/second in a tangential flow pattern. This velocity can be affected by the outside diameter of the screen and the internal diameter of the vessel. Additionally, the open area of the screen determines the overall size of the housing, and may be limited by screen manufacturing process of and size limitations imposed by the end user.

The scrubbing action provided by the crossflow during filtration helps to prolong the operational cycle, but may not entirely prevent the need for an additional cleaning mechanism. As such, an automatic spray cleaning unit 42 can be provided with the crossflow filtration unit 15. The spray cleaning unit 42 can include a high pressure pump connected to a high pressure input device 7 which is connected to a central spray pipe 44 which has an array of spray nozzles 3. The central spray pipe 44 is connected to a rotational device 2 that allows for the rotation of the central spray pipe 44. The pressure from the high pressure (700 to 800 psi.) pump is introduced into the low pressure area of the screen through the high pressure inlet device 7 to the central spray pipe 44 and the spray nozzles 3. The high pressure pump is utilized to improve the efficiency of the filter through more efficient cleaning. Many filtration processes utilize back pulsing or backwashing of the screen or filter media to effect the cleaning. This process requires large amounts of the filtrate or another liquid to accomplish this task. The high pressure is used to convert the energy of the high pressure, low volume, spray of the nozzles into an effective, point source cleaning.

Suitably, the central spray pipe 44 and spray nozzles 3 are located on the inside area 38 of the screen 4. Suitably, the central spray pipe 44 extends substantially along the longitudinal axis of the crossflow filtration housing 1. The rotational device 2, is used to rotate the central spray pipe 44, effectively cleaning the inside surface of the screen 4. The rotation of a central spray pipe 44 is most effective in maintaining a high pressure, high energy, blast suitably centered to a specific square inch of the screen 4 at one time. Attempting to spray all surfaces at one time diffuses the energy resulting in less cleaning of the open area of the screen. In one embodiment, the rotational device 2 can use an air motor with a gear reducer that operates on 10 to 50 psi compressed air. Also, in one embodiment the rotational speed can be variable between 1 to 10 revolutions per minute. Alternate driving means are provided for rotating the shaft in other embodiments. Cleaning fluid (in some embodiments, water from the clean water source) can be supplied to the spray nozzles 3 through the central spray pipe 44. During a cleaning cycle, the spray nozzles 3 can spray cleaning fluid radially outward while being spun with the shaft about the shaft axis to impart a circumferential velocity component to the spray of cleaning fluid. The design of the screen 4 with an internal v-shaped wedge allows for the high pressure water that flows through the cleaning nozzles 3 to be directed into the slots that are to be cleaned. Pressurized air, as opposed to fluid, can also be used with the spray nozzles 3 to clean the screen 4.

The spray cleaner unit 42 is designed to maximize the use of the open area of the screen 4 by cleaning every square inch of the screen 4. This can be accomplished in one embodiment by: 1) selecting the distance between the screen 4 and the nozzle 3 to concentrate most of the energy of the water blast on a specific area; 2) selecting the spray nozzle 3 pattern and the distance between nozzles 3 being positioned to suitably create an overlap 10% to 20% at the selected distance between the screen 4 and the nozzles 3; 3) selecting a size of nozzles 3 according to the pressure used to maintain the energy while keeping the volume as low as possible; and 4) arranging the nozzles 3 in an alternating pattern, 180 degrees from each other to oppose the resulting force.

The solid filtrate separated by the crossflow separator 50 can be removed from the crossflow filtration housing 1 by shutting off the input 6 of multi-phase fluid, and draining the filtration housing 1 through the purge outlet 14. The purge outlet 14 can drain the remaining liquid and solid material into a catch tank positioned below the outlet 14, or can be fitted with a pipe and drained, by gravity or pump, to a storage tank at another location. In some embodiments, prior to operating a cleaning cycle with the spray nozzles 3, the crossflow filtration housing 1 is evacuated of fluid. The fluid in the crossflow filtration housing 1 (both outside 40 and inside 38 the filter screen 4) can be drained and may be forcibly blown out of the vessel by the cleaning nozzles 3. In some embodiments, an enlarged blowdown check valve 5 is used to improve the evacuation of any filtrate remaining in the inner chamber.

Once emptied of process fluid, the crossflow filtration housing 1 is cleaned by the spray nozzles 3 with a low volume, high pressure (in some embodiments, between about 500 psi and about 1000 psi) stream of cleaning fluid. Because the housing 1 is not filled with process fluid, the velocity and force of the cleaning fluid at the outlets of the spray nozzles 3 can be maintained to impact the filter screen 4 and penetrate them. This can enable a more effective cleaning cycle, as energy from the spray nozzles 3 is not absorbed by an intermediate liquid between the spray nozzles 3 and the filter screen 4. In some embodiments, the amount of cleaning fluid required for cleaning the filter screen 4 is about 1 percent or less of the volume of the process fluid being filtered. The various stages of operation of the crossflow filtration unit are illustrated in FIG. 13. In another embodiment, the process fluid can be retained in the system so as to avoid waste.

In some embodiments, the cleaning cycle can be programmed for automatic operation. The programming can include manipulation of overall duration, rotation of the shaft and nozzles, and fluid pressure, and the like.

The crossflow filter 50 can also contain a system of controllers and sensors that can sense and/or control the flow, temperature, pressure, pH, concentration, etc. of the crossflow filter 50. These controllers and sensors, as well as various pressure valves and pumps can be wired to a central electrical control panel. Controllers can be activated with either electrical signals converted to air pressure signals or direct electrical signals. Input sensor signals are electrical. The electrical control panel connects these signals with a microprocessor controller. This can be a PLC (programmable logic controller) as Allen-Bradley, Siemens, GE Fanuc etc. or some other devices such as Accutech A/D converters, Opto 22 controllers, National Instruments modules etc. that convert electrical analog signals to digital signals which are sent to a PC for processing and display. The automation and control system is a PC based system.

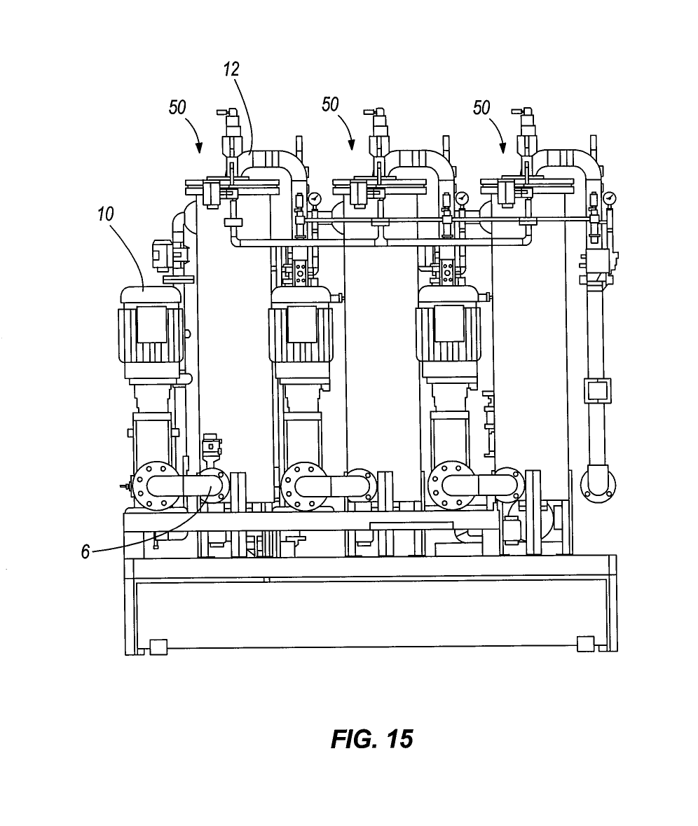

As discussed above, the filter screens 4 used in the second phase of a multiple phase separation system can be provided in many sizes of micron openings. The screen size is determined by the particle size to be separated. The number of crossflow filtration stations or units in the second phase is variable to meet varied challenges and flow rates. FIG. 15 shows the use of three crossflow filtration units connected in series. In some embodiments, the second phase can be configured to allow the use of less and/or less expensive filtration media downstream of the second phase. In some embodiments, the filter screens and the number of filtration stations in the second phase can be configured to allow the use of less sophisticated ultra filtration membranes, which are reasonably priced and commercially available.

In the exemplary waste recovery system depicted in FIG. 1, the second phase separation using the crossflow filter can filter the first filtered liquid of the first phase to remove about an additional 14 percent of total phosphorus, about an additional 30 percent of total potassium, and about an additional 10 percent of total nitrogen from the first filtered liquid. The concentrated solids removed from the first filtered fluids at this second phase can be further dehydrated with the screw press with the solids from the first phase and used for bedding or compost. The second filtered liquid (now twice concentrated) can be routed to the third phase of the separation system. A portion of the second filtered liquid not routed to the third phase can be used for secondary supporting operations. Such supporting operations can include flushing barn stalls and cleaning the filtering media used in the first phase, among others.

The third phase of the separation system can be an ultra-filtration process done by membrane filtration. Suitably the ultra-filtration membranes have nominal pore size to allow for the passage of particles that are no larger than 0.5 microns to 0.002 microns in diameter. The selection of the pore size is based upon the extent of the particle size capture necessary and the performance of the membrane i.e. the permeation rate with the specific materials to be filtered. With more open membranes a higher permeation rate is obtained, and less solids are captured. However in manure applications the tighter membranes many times have an overall higher permeation rate over time as large particles get “stuck” or entrained in the more open pores and block flow where they do not become entrained in the tighter membranes. Suitable types of membrane materials include PVDF (Polyvinylidene Difluoride) membranes, polyamide film, cellulose acetate, polyethersulphone, polysulophone, polyacrylonitrile, fluoropolymer and aluminum oxide-ceramic base. Such membranes are commercially available from such producers as Koch Industries, Aquious-PCI membranes, FilmTec/DOW, Millipore, Pall Corp., Corning, BOC Group, DuPont, Media and Process Tech, X-Flow. The products of this phase are a third filtered liquid and a liquid concentrate fertilizer material containing all of the suspended materials removed from the third filtered liquid. The third filtered liquid produced reduces the total nitrogen, phosphorus, and potassium values to about 10 percent, less than about 1 percent, and about 18.5 percent of the original values found in the starting multi-phase fluid, respectively. The total output of the third filtered liquid could be spread on a smaller land area for a typical farm, in some instances reducing land spreading needs by about 90 percent for its daily hydraulic loading. The other option for the third filtered liquid is further processing in a fourth phase to remove all of the dissolved solids. The valuable nutrients are saved, not lost, in the reduced volume liquid concentrate fertilizer portion and can be stored in a more convenient form than raw manure and used on crops with reduced hauling costs. The remaining third filtered liquid is about 0 percent solids and about 0.6 percent total dissolved solids.

The fourth phase of the separation system can be a reverse osmosis membrane filtration process. Suitably, the reverse-filtration membranes have nominal pore sizes that allow for the passage of particles that are no larger than 0.001 microns to 0.0001 microns in diameter. Suitably, the pore size selection is based upon the ions being separated and the permeation rate vs. max pressure of the system. For manure separation, calcium and silicate ions are the major determination of the type of membrane used. Suitable membrane materials include aromatic polyamides and cellulose acetate. Such membranes are commercially available from Koch Industries, GE Water, FilmTec/DOW, Pall Corp., DuPont and other producers. At the fourth phase, any remaining contaminants are eliminated from the third filtered liquid. In the waste recovery system, the resulting fourth filtered liquid (water) may be used as drinking water and/or washing water for the cattle. Once used for either of these purposes, the water can go back to the first phase and complete the recycling circle. The fourth phase filtration can take out the dissolved minerals and output water with about 0 percent each phosphorus and potassium, and about 0.005 percent nitrogen. In some embodiments, the total dissolved solids can be about 60 parts per million (ppm).

The separation system is generally modular in that the four individual phases can be included as desired and/or required for a particular application. In addition, each individual phase can include various filtration or separation components to account for varied separation results and flow rates, etc.

The separation system in one embodiment is suitable for separation of the digestive waste of cattle. However, the separation system as described and illustrated herein can be equally well-suited to process other working fluids/solids. The separation system can be used to separate particulate and dissolved solids from virtually any liquid and subsequently filter or otherwise purify the liquid.

1. A crossflow filtration unit comprising:
a housing having a top, a bottom, a sidewall and an inside;
a filter screen positioned on the inside of the housing; the screen having an exterior, an interior, and a bottom;
an inside area in the interior of the filter screen and an outside area between the exterior of the filter screen and the housing;
an inlet opening positioned on the housing, the inlet positioned to direct fluid in helical direction around the inside of the housing; and
an outlet opening in the top of the housing, the outlet opening allowing fluid communication with the inside area.

2. The crossflow filtration unit of claim 1 further comprising a purge outlet opening on the bottom of the housing allowing fluid communication with the outside area.

3. The crossflow filtration unit of claim 1 further comprising a recycle outlet opening on the sidewall of the housing allowing fluid communication with the outside area.

4. The crossflow filtration unit of claim 3 wherein the recycle outlet opening is operatively connected to the inlet opening.

5. The crossflow filtration unit of claim 1 wherein the filter screen has openings which allow for the passage of particles that are no larger than approximately 50-400 microns in diameter.

6. The crossflow filtration unit of claim 1 wherein the filter screen has v-shaped grooves on the interior of the filter screen.

7. The crossflow filtration unit of claim 9 further comprising a spray cleaner unit, the spray cleaner unit comprising:
a rotational device;
a central spray pipe operatively connected to the rotational device and a fluid or air source; and
a plurality of horizontally arranged spray nozzles operatively connected to the central spray pipe;
wherein the central spray pipe is positioned within the inside area.

8. The crossflow filtration unit of claim 7 wherein:
the filter screen has v-shaped grooves on the interior of the filter screen; and
wherein the horizontally arranged spray nozzles are positioned to direct fluid or air towards the v-shaped grooves of the filter screen.

9. A crossflow filtration unit comprising:
a cylindrical housing having a top, a bottom, a sidewall, an inside, a longitudinal axis, a latitudinal axis and a plurality of radial axes;
a cylindrical filter screen positioned on the inside of the cylindrical housing; the screen having an exterior, an interior, and a bottom;
an inside area in the interior of the cylindrical filter screen and an outside area between the exterior of the cylindrical filter screen and the cylindrical housing;
an inlet opening positioned on the cylindrical housing, the inlet positioned to direct fluid in a direction perpendicular to the latitudinal axis of the cylindrical housing, wherein the inlet does not direct the flow of fluid in line with any of the radial axes of the cylindrical housing; and
an outlet opening in the top of the cylindrical housing, the outlet opening allowing fluid communication with the inside area.

10. The crossflow filtration unit of claim 9 further comprising a purge outlet opening on the bottom of the cylindrical housing allowing fluid communication with the outside area.

11. The crossflow filtration unit of claim 9 further comprising a recycle outlet opening on the sidewall of the cylindrical housing allowing fluid communication with the outside area.

12. The crossflow filtration unit of claim 11 wherein the recycle outlet opening is operatively connected to the inlet opening.

13. The crossflow filtration unit of claim 9 wherein the cylindrical filter screen has openings which allow for the passage of particles that are no larger than approximately 50-400 microns in diameter.

14. The crossflow filtration unit of claim 9 wherein the cylindrical filter screen has v-shaped grooves on the interior of the cylindrical filter screen.

15. The crossflow filtration unit of claim 9 further comprising a spray cleaner unit, the spray cleaner unit comprising:
a rotational device;
a central spray pipe operatively connected to the rotational device and a fluid or air source; and
a plurality of horizontally arranged spray nozzles operatively connected to the central spray pipe;
wherein the central spray pipe is positioned within the inside area.

16. The crossflow filtration unit of claim 15 wherein:
the cylindrical filter screen has v-shaped grooves on the interior of the cylindrical filter screen; and
wherein the horizontally arranged spray nozzles are positioned to direct fluid or air towards the v-shaped grooves of the cylindrical filter screen.

17. A crossflow filtration unit comprising:
a cylindrical housing having a top, a bottom, a sidewall, an inside, a longitudinal axis, a latitudinal axis and a plurality of radial axes;
a cylindrical filter screen positioned on the inside of the cylindrical housing; the screen having an exterior, an interior, and a bottom;
an inside area in the interior of the cylindrical filter screen and an outside area between the exterior of the cylindrical filter screen and the cylindrical housing;
an inlet opening positioned on the cylindrical housing, the inlet positioned to direct fluid in a direction perpendicular to the latitudinal axis of the cylindrical housing, wherein the inlet does not direct the flow of fluid in line with any of the radial axes of the cylindrical housing;
an outlet opening in the top of the cylindrical housing, the outlet opening allowing fluid communication with the inside area;
a purge outlet opening on the bottom of the cylindrical housing allowing fluid communication with the outside area; and
a recycle outlet opening on the sidewall of the cylindrical housing allowing fluid communication with the outside area, wherein the recycle outlet opening is operatively connected to the inlet opening.

18. The crossflow filtration unit of claim 17 wherein the cylindrical filter screen has openings which allow for the passage of particles that are no larger than approximately 50-400 microns in diameter.

19. The crossflow filtration unit of claim 17 wherein the cylindrical filter screen has v-shaped grooves on the interior of the cylindrical filter screen.

20. The crossflow filtration unit of claim 17 further comprising a spray cleaner unit, the spray cleaner unit comprising:
a rotational device;
a central spray pipe operatively connected to the rotational device and a fluid or air source; and
a plurality of horizontally arranged spray nozzles operatively connected to the central spray pipe;
wherein the central spray pipe is positioned within the inside area.

21. The crossflow filtration unit of claim 20 wherein:
the cylindrical filter screen has v-shaped grooves on the interior of the cylindrical filter screen; and
wherein the horizontally arranged spray nozzles are positioned to direct fluid or air towards the v-shaped grooves of the cylindrical filter screen.

22. A multi-phase separation system for separating a mixed-phase fluid, the system comprising:
a first filtration unit selected from the group consisting of a dissolved air floatation separator, a centrifuge, a rotary drum screen filter, a stationary inclined screen, a screw press, a roller press, a belt press, or digester; and
a second filtration unit which is a filtration unit that will filter out all sold particles larger than 250 microns, wherein the first and second filtration unit are operatively connected.

23. The multiphase separation system of claim 22 wherein the second filtration unit is selected from the group consisting of a centrifuge, dead end filter banks, a dissolved air flotation separator, or the crossflow filtration unit of claim 1.

24. The multiphase separation system of claim 23 wherein the second filtration unit is the crossflow filtration unit of claim 1.

25. The multi-phase separation system of claim 22 further comprising a third filtration unit which is membrane filter, wherein the second and third filtration unit are operatively connected.

26. The multi-phase separation system of claim 25 wherein the membrane filter contains individual pores which allow for the passage of particles that are no larger than 50 microns to 400 microns in diameter.

27. The multi-phase separation system of claim 25 further comprising a fourth filtration unit which is a reverse osmosis membrane filter, wherein the third and forth filtration unit are operatively connected.

28. The multi-phase separation system of claim 27 wherein the reverse osmosis membrane filter contains individual pores which allow for the passage of particles that are no larger than about 0.001 microns to 0.0001 microns in diameter.

29. A multi-phase separation system for separating a mixed-phase fluid, the system comprising:
a first filtration unit selected from the group consisting of a dissolved air floatation separator, a centrifuge, a rotary drum screen filter, a stationary inclined screen, a screw press, a roller press, a belt press, or digester; and
a second filtration unit which is the crossflow filtration unit of claim 1.

30. The multi-phase separation system of claim 29 further comprising a third filtration unit which is membrane filter, wherein the second and third filtration unit are operatively connected.

31. The multi-phase separation system of claim 30 wherein the membrane filter contains individual pores which allow for the passage of particles that are no larger than 50 microns to 400 microns in diameter.

32. The multi-phase separation system of claim 30 further comprising a fourth filtration unit which is a reverse osmosis membrane filter, wherein the third and forth filtration unit are operatively connected.

33. The multi-phase separation system of claim 32 wherein the reverse osmosis membrane filter contains individual pores which allow for the passage of particles that are no larger than about 0.001 microns to 0.0001 microns in diameter.

34. A method of filtering a mixed-phase fluid into a filtered liquid and at least one concentrated solid, the method comprising:
filtering the mixed-phase fluid through a first filtration unit selected from the group consisting of a dissolved air floatation separator, a centrifuge, a rotary drum screen filter, a stationary inclined screen, a screw press, a roller press, a belt press, or digester, producing a first concentrated solid and a first filtered liquid; and
filtering the first filtered liquid through a second filtration unit which is the crossflow filtration unit of claim 1.

35. The method of claim 27 wherein all particles larger than 250 microns are removed from the mixed-phase fluid by the first filtration unit to produce the first filtered liquid.

36. The method of claim 27 wherein the mixed-phase fluid is manure and wherein about 50 percent of total phosphorus, about 20 percent of total potassium, and about 25 percent of total nitrogen present in the manure is removed from the mixed-phase fluid by the first filtration unit to produce the first filtered liquid.

37. The method of claim 27 wherein the mixed-phase fluid is manure and wherein about 50-65 of suspended solid particles in the manure are removed from the mixed-phase fluid by the first filtration unit to produce the first filtered liquid.

38. The method of claim 27 wherein the mixed-phase fluid is manure and the first concentrated solid is further dehydrated by a screw press.

39. The method of claim 27 wherein the mixed-phase fluid is manure and wherein about 14 percent of total phosphorus, about 30 percent of total potassium, and about 10 percent total nitrogen present in the first filtered liquid are removed by the second filtration unit to produce the second filtered liquid.

40. The method of claim 27 wherein the mixed-phase fluid is manure and wherein about 5-10 of suspended solid particles are removed from the first filtered liquid by the second filtration unit to produce the second filtered liquid.

41. The method of claim 27 wherein the mixed-phase fluid is manure and the second concentrated solid is further dehydrated by a screw press.

42. The method of claim 27 further comprising the steps of filtering the second filtered liquid through a third filtration unit which is membrane filter, producing a third filtered liquid.

43. The method of claim 35 wherein the mixed-phase fluid is manure and the total phosphorus levels in the third filtered liquid is less than about one percent of the total phosphorous levels in the manure, the total potassium levels in the third filtered liquid is about 18.5 percent of the total phosphorous levels in the manure, and the total nitrogen levels in the third filtered liquid is about 10 percent of the total nitrogen levels in the manure.

44. The method of claim 27 further comprising the steps of filtering the third filtered liquid through a fourth filtration unit which is a reverse osmosis membrane filter, producing a fourth filtered liquid.

45. A method of filtering a mixed-phase fluid into a filtered liquid and at least one concentrated solid, the method comprising:
filtering the mixed-phase fluid through a first filtration unit selected from the group consisting of a dissolved air floatation separator, a centrifuge, a rotary drum screen filter, a stationary inclined screen, a screw press, a roller press, a belt press, or digester, producing a first concentrated solid and a first filtered liquid; and
filtering the first filtered liquid through a second filtration unit that will filter out all sold particles larger than 250 microns.

46. The method of claim 45 wherein the second filtration unit is selected from the group consisting of a centrifuge, dead end filter banks, a dissolved air flotation separator, or the crossflow filtration unit of claim 1.

47. The method of claim 45 further comprising the steps of filtering the second filtered liquid through a third filtration unit which is membrane filter, producing a third filtered liquid.

48. The method of claim 47 further comprising the steps of filtering the third filtered liquid through a fourth filtration unit which is a reverse osmosis membrane filter, producing a fourth filtered liquid.

49. A method of filtering a mixed-phase fluid into a filtered liquid and at least one concentrated solid, the method comprising:
filtering the mixed-phase fluid through a first filtration unit selected from the group consisting of a dissolved air floatation separator, a centrifuge, a rotary drum screen filter, a stationary inclined screen, a screw press, a roller press, a belt press, or digester, producing a first concentrated solid and a first filtered liquid;
filtering the first filtered liquid through a second filtration unit which is a crossflow filtration unit of claim 1, producing a second concentrated solid and a second filtered liquid;
filtering the second filtered liquid through a third filtration unit which is membrane filter, producing a third filtered liquid; and
filtering the third filtered liquid through a fourth filtration unit which is a reverse osmosis membrane filter, producing a fourth filtered liquid.
